(19) United States
(12) Patent Application Publication
(10) Pub. No.: US 2008/0140301 A1
(43) Pub. Date: Jun. 12, 2008

(54) System and Method for Improving Accuracy of a Gas Sensor

(76) Inventors: Yi Ding, Canton, MI (US); Richard Soltis, Saline, MI (US); David Kubinski, Canton, MI (US)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/561,751

(22) Filed: Nov. 20, 2006

(51) Int. Cl. F01N 9/00; G01N 7/00

(52) U.S. Cl. 701/115; 73/23.31

(57) ABSTRACT

A method of operating an electrochemical gas sensor is disclosed, wherein the method includes applying a voltage pulse across a measuring electrode pair, and detecting a current through the measuring electrode pair during the voltage pulse before the current decays to a steady state level.

### BACKGROUND AND SUMMARY

Gas concentration sensors may be used to monitor the concentrations of species in various environments. For example, a NOx sensor may be used to detect the concentration of nitrogen oxide emissions (collectively “NOx”) in the exhaust of an automobile or truck tailpipe. A NOx sensor generally operates by electrochemically dissociating NOx and measuring an electrical current resulting from the conduction of the oxygen ions through a solid state electrolyte.

As emission standards become more restrictive, sensor accuracy becomes increasingly important to provide accurate feedback for controlling processes and parameters related to emissions control. However, as a sensor ages, defects may develop in the sensor structure that cause changes in the impedance of the sensor. These defects may cause the accuracy of the sensor to decrease over time.

The inventors herein have realized that an aged electrochemical gas sensor such as a NOx sensor may provide a more accurate output when operated by applying a voltage pulse across a measuring electrode pair, and detecting a current through the measuring electrode pair during the voltage pulse before the current decays to a steady state level. Such a method of operating a sensor may allow a measurement to be acquired will less influence from impedances arising from sensor aging. Such a method may also facilitate verification of measurements by allowing multiple measurements to be made over an interval. In addition, such a method may provide a relatively large signal and good signal-to-noise ratios for increased sensitivity and therefore may facilitate the measurement of lower signals.

### BRIEF DESCRIPTION OF THE DRAWINGS

FIG. 1 is a schematic depiction of an exemplary embodiment of an internal combustion engine.

FIG. 2 is a schematic depiction of a first exemplary embodiment of a NOx sensor.

FIG. 3 is a schematic depiction of a second exemplary embodiment of a NOx sensor.

FIG. 4 is a graph depicting an exemplary relationship between pumping current and pumping voltage for O₂ and NOx of varying concentrations for an exemplary NOx sensor.

FIG. 5 is a graph depicting an output of an exemplary NOx sensor as a function of measurement time and pumping electrode voltage.

FIG. 6 is a graph depicting an output of an exemplary NOx sensor as a function of NO concentration and measurement time.

FIG. 7 is a flow chart showing an embodiment of method for determining a gas sensor output.

### DETAILED DESCRIPTION OF THE DEPICTED EMBODIMENTS

The present disclosure provides various embodiments of methods of operating a gas sensor that may reduce measurement errors caused by such factors as sensor aging and manufacturing variability. NOx sensors are typically operated in a steady-state mode wherein the sensor provides a continuous output based upon an ionic current caused by the electrochemical pumping of oxygen from dissociated NOx molecules. However, this current may vary over time and/or between different sensors of the same design due to factors such as sensor aging. For example, without wishing to be bound by theory, as a NOx sensor ages, the impedance of the detector electrolyte and/or the electrolyte-electrode interfaces may change over time due to polarization effects caused by structural changes in the electrolyte and/or at the interfaces.

The embodiments disclosed herein may help overcome such problems encountered with steady state sensor operation by determining a species concentration based on a current detected after applying a voltage across the sensor measuring electrodes, but before the detected current decays to a steady state value. Without wishing to be bound by theory, the steady state measurement current of a NOx sensor may be dependent upon impedances arising from polarization effects within the sensor, while the instantaneous current may be less subject to such effects. The methods disclosed herein may be used in any suitable sensor and/or application, including but not limited to the monitoring of species such as NOx in automotive exhaust. These methods are discussed in further detail below.

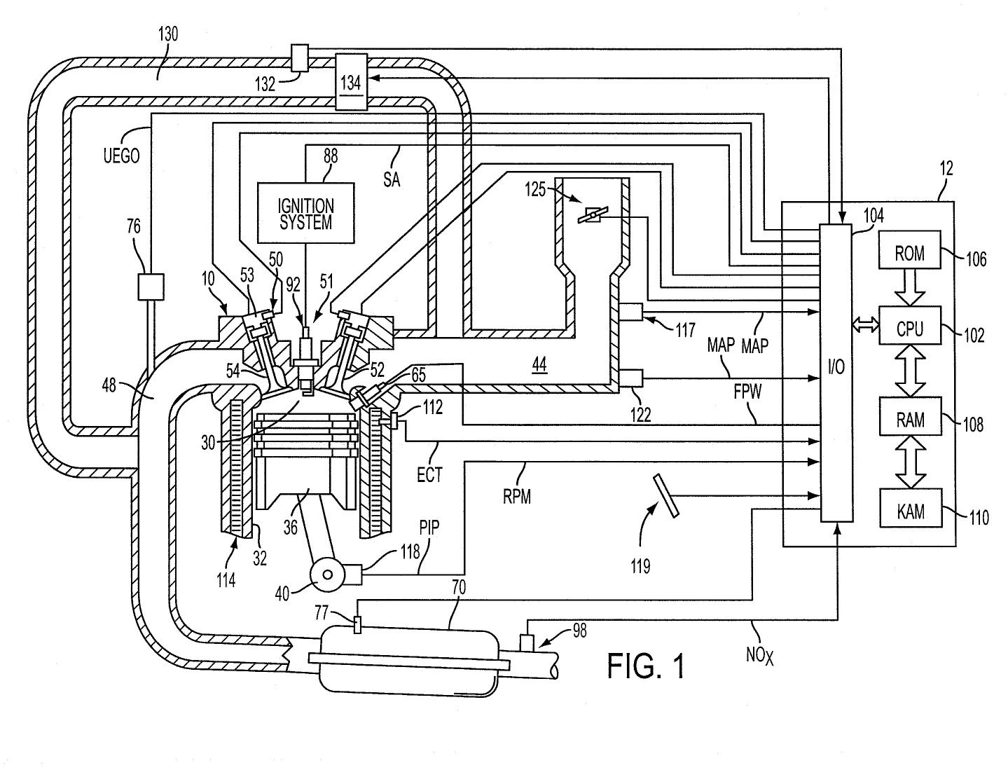

FIG. 1 shows an exemplary embodiment of an internal combustion engine 10, comprising a plurality of combustion chambers (one of which is indicated at 30), controlled by electronic engine controller 12. Combustion chamber 30 of engine 10 includes combustion chamber walls 32 with piston 36 positioned therein and connected to crankshaft 40. Combustion chamber 30 is shown communicating with intake manifold 44 and exhaust manifold 48 via respective intake valve 52 and exhaust valve 54. Fuel injector 65 is shown directly coupled to combustion chamber 30 for delivering liquid fuel directly therein in proportion to the pulse width of a signal (FPW) received from controller 12. However, in some embodiments, a fuel injector may be positioned in intake manifold 44, thereby providing port injection.

Intake air flow through intake manifold 44 may be adjusted with throttle 125, which is controlled by controller 12. An ignition spark may be provided to combustion chamber 30 via spark plug 92 in response to a spark signal from controller 12. Alternatively, spark plug 92 may be omitted for a compression ignition engine. Further, controller 12 may activate fuel injector 65 during the engine operation so that a desired air-fuel mixture is formed when ignition power is supplied to spark plug 92 by ignition system 88. Controller 12 controls the amount of fuel delivered by fuel injector 65 so that the air-fuel ratio mixture in chamber 30 may be selected to be substantially at (or near) stoichiometry, a value rich of stoichiometry, or a value lean of stoichiometry.

Intake valve 52 may be controlled by controller 12 via electric valve actuator (EVA) 51. Similarly, exhaust valve 54 may be controlled by controller 12 via EVA 53. During some conditions, controller 12 may vary the signals provided to actuators 51 and 53 to control the opening and closing of the respective intake and exhaust valves. The position of intake valve 52 and exhaust valve 54 may be determined by valve position sensors 55 and 57, respectively. In alternative embodiments, one or more of the intake and exhaust valves may be actuated by one or more cams, and may utilize one or more of cam profile switching (CPS), variable cam timing (VCT), variable valve timing (VVT) and/or variable valve lift (VVL) systems to vary valve operation. For example, cylinder 30 may alternatively include an intake valve controlled via electric valve actuation and an exhaust valve controlled via cam actuation including CPS and/or VCT.

Controller 12 is shown in FIG. 1 as a conventional microcomputer including: microprocessor unit 102, input/output ports 104, an electronic storage medium of executing programs and calibration values, shown as read-only memory chip 106 in this particular example, random access memory 108, keep alive memory 110, and a conventional data bus.

Controller 12 is shown receiving various signals from sensors coupled to engine 10, including: measurement of inducted mass air flow (MAF) from mass air flow sensor 117; accelerator pedal position from pedal position sensor 119; engine coolant temperature (ECT) from temperature sensor 112 coupled to cooling sleeve 114; a profile ignition pickup signal (PIP) from Hall effect sensor 118 coupled to crankshaft 40 giving an indication of engine speed (RPM); and absolute Manifold Pressure Signal (MAP) from sensor 122. Engine speed signal RPM is generated by controller 12 from signal PIP in a conventional manner and manifold pressure signal MAP provides an indication of engine load.

An exhaust gas recirculation (EGR) passage 130 is shown communicating with exhaust manifold 48 and intake manifold 44. The amount of EGR supplied to the intake manifold may be adjusted by EGR valve 134, which is in communication with controller 12. Further, controller 12 may receive a signal from EGR sensor 132, which may be configured to measure temperature or pressure of the exhaust gas within the EGR passage.

Exhaust gas oxygen sensor 76 is shown coupled to exhaust manifold 48 upstream of exhaust after-treatment system 70. Exhaust gas oxygen sensor 76 may be configured to provide a signal to controller 12, which indicates whether exhaust air-fuel ratio is either lean of stoichiometry or rich of stoichiometry. Exhaust after-treatment system 70 may include a catalytic converter, a lean NOx trap, and/or any other suitable treatment device. Exhaust after-treatment sensor 77 may be configured to provide a signal to controller 12 indicative of the condition of the exhaust after-treatment system 70 and may include measurement of temperature, pressure, etc.

A NOx sensor 98 is shown coupled to exhaust manifold 48 downstream of exhaust after-treatment system 70. NOx sensor 98 may be configured to output a signal to controller 12 in response to a detected concentration of NOx in the engine exhaust, as will be described in more detail below. NOx sensor 98 may also be configured to receive a signal from controller 12, such as a control signal for controlling a temperature of the sensor, a voltage applied to electrodes in the sensor, etc. In an alternative embodiment, sensor 98 may be configured to measure the concentration of other species besides NOx, including but not limited to O₂, CO, H₂O, SOx, and other oxygen-containing gases.

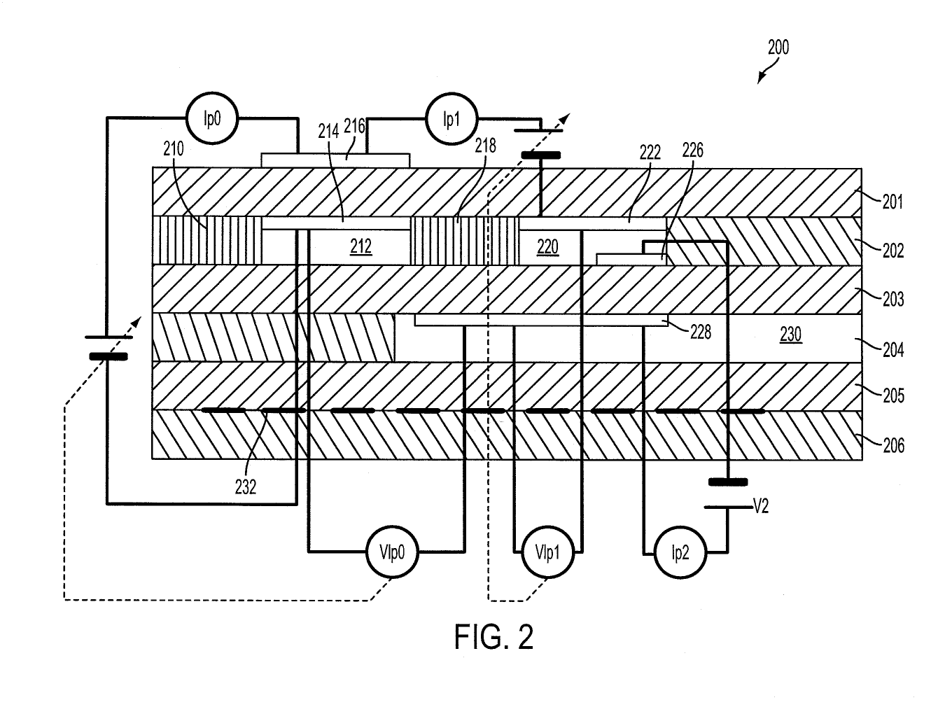

NOx sensor 98 may be used both for control of the after-treatment system and for on-board diagnostics (OBD) to ensure the vehicle does not exceed the NOx emissions standards. One example of a NOx sensor is disclosed in U.S. Pat. No. 5,288,375. Many variations of NOx sensors exist. FIG. 2 shows a schematic view of an exemplary embodiment of a NOx sensor configured to measure a concentration of NOx gases in an emissions stream. The term NOx as used herein may refer to any combination of nitrogen and oxygen, including but not limited to NO and NO₂. Sensor 200 comprises a plurality of layers of one or more ceramic materials arranged in a stacked configuration. These layers of ceramic materials are depicted as layers 201, 202, 203, 204, 205 and 206. Layers 201-206 may be formed from any suitable material, including but not limited to oxygen ion conductors such as zirconium oxide-based materials. Further, in some embodiments, a heater 232 may be disposed between the various layers (or otherwise in thermal communication with the layers) to increase the ionic conductivity of the layers. While the depicted NOx sensor is formed from six ceramic layers, it will be appreciated that the NOx sensor may include any other suitable number of ceramic layers.

Layer 202 includes a material or materials creating a first diffusion path 210. First diffusion path 210 is configured to introduce exhaust gases into a first internal cavity 212 via diffusion. A first pair of pumping electrodes 214 and 216 is disposed in communication with internal cavity 212, and is configured to electrochemically pump a selected exhaust gas constituent from internal cavity 212 through layer 201 and out of sensor 200. Generally, the species pumped from internal cavity 212 out of sensor 200 may be a species that may interfere with the measurement of a desired analyte. In a NOx sensor, molecular oxygen can potentially interfere with the measurement of NOx at a measuring electrode, as oxygen is dissociated and pumped at a lower potential than NOx. Therefore, where oxygen and NOx are both present at an electrode configured to measure NOx concentration, the resulting output signal may include contributions from ionic current caused by the dissociation of both NOx and O₂. Removal of the oxygen from the analytic exhaust gas sample in sensor 200 may allow NOx concentration to be measured substantially without interference from oxygen.

First diffusion path 210 may be configured to allow one or more components of exhaust gases, including but not limited to oxygen and NOx gases, to diffuse into internal cavity 212 at a slower rate than the interfering component can be electrochemically pumped out by first pair of pumping electrodes 214 and 216. Pumping electrodes 214 and 216 may be referred to herein as a first pumping electrode configuration. In this manner, oxygen may be removed from first internal cavity 212 to reduce interfering effects caused by oxygen.

The process of electrochemically pumping the oxygen out of first internal cavity 212 includes applying an electric potential V_{Ip0} across first pair of pumping electrodes 214, 216 that is sufficient to dissociate molecular oxygen, but not sufficient to dissociate NOx. With the selection of a material having a suitably low rate of oxygen diffusion for first diffusion path 210, the ionic current Ip0 between first pair of pumping electrodes 214, 216 may be limited by the rate at which the gas can diffuse into the chamber, which is proportional to the concentration of oxygen in the exhaust gas, rather than by the pumping rate of first pair of pumping electrodes 214, 216. This may allow substantially all oxygen to be pumped from first internal cavity 212 while leaving NOx gases in first internal cavity 212.

Sensor 200 further includes a second internal cavity 220 separated from the first internal cavity by a second diffusion path 218. Second diffusion path 218 is configured to allow exhaust gases to diffuse from first internal cavity 212 into second internal cavity 220. A second pumping electrode 222 optionally may be provided in communication with second internal cavity 220. Second pumping electrode 222 may, in conjunction with electrode 216, be set at an appropriate potential V_{Ip1} to remove additional residual oxygen from second internal cavity 220. Second pumping electrode 222 and electrode 216 may be referred to herein as a second pumping electrode configuration. Alternatively, second pumping electrode 222 may be configured to maintain a substantially constant concentration of oxygen within second internal cavity 220. In some embodiments, V0 may be approximately equal to V1, while in other embodiments V0 and V1 may be different. While the depicted embodiment utilizes electrode 216 to pump oxygen from first internal cavity 212 and from second internal cavity 220, it will be appreciated that a separate electrode (not shown) may be used in conjunction with electrode 222 to form an alternate pumping electrode configuration to pump oxygen from second internal cavity 220.

Sensor 200 further includes a measuring electrode 226 and a reference electrode 228. Measuring electrode 226 and reference electrode 228 may be referred to herein as a measuring electrode configuration. Reference electrode 228 is disposed at least partially within or otherwise exposed to a reference air duct 230. Measuring electrode 226 may be set at a sufficient potential relative to reference electrode to pump NOx out of second internal cavity 220. The sensor output is based upon the pumping current flowing through measuring electrode 226 and pumping electrode 228, which is proportional to the concentration of NOx in second internal cavity 220.

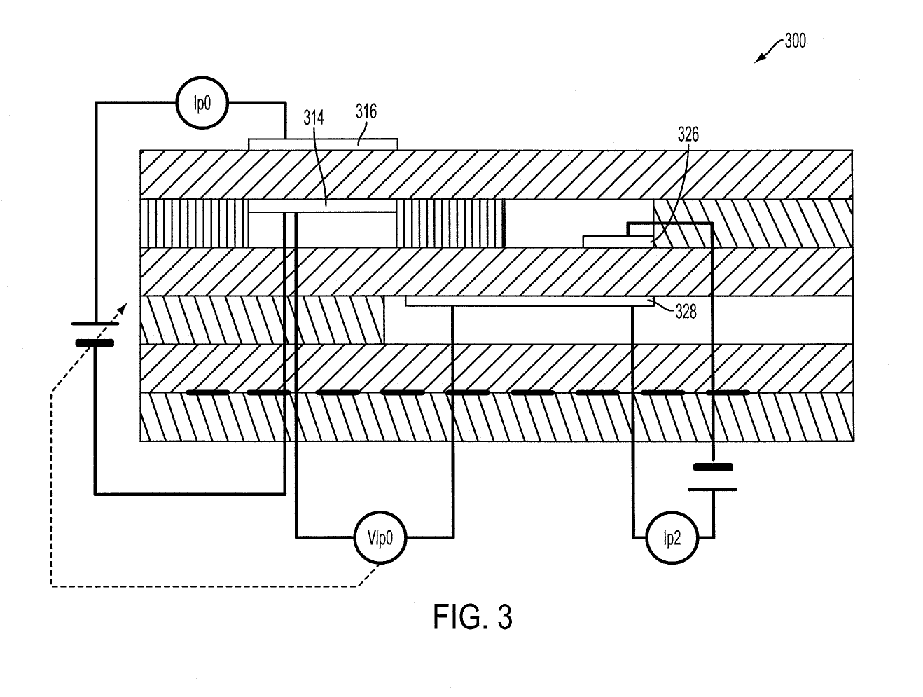

FIG. 3 shows an alternative embodiment of the NOx sensor 200 described above with reference to FIG. 2. Sensor 300 of FIG. 3 is shown having components similar to FIG. 2, while utilizing only one pair of pumping electrodes 314, 316 for removing an interfering species (i.e. pumping electrode 222 is not included). Because sensor 300 is shown having only one pair of pumping electrodes compared to the two pairs of pumping electrodes of sensor 200, the oxygen concentration reaching measuring electrodes 326, 328 may be different than the oxygen concentration reaching measuring electrodes 226, 228 in sensor 200. Furthermore, in some embodiments, a NOx sensor may include only one diffusion path and one internal cavity, thereby placing the pumping electrode and measuring electrode in the same internal cavity.

It should be understood that the exemplary embodiments of sensors described above with reference to FIGS. 2 and 3 are not intended to be limiting, and any other suitable sensor having any other configuration and/or materials may be used. Further, the methods disclosed herein may also be applied to sensors other than those used to detect NOx, including but not limited to CO, CO₂, SOx, and H₂O sensors.

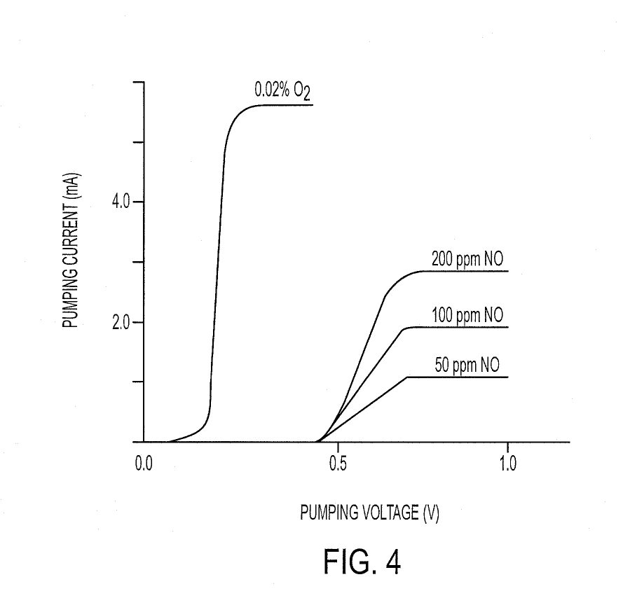

FIG. 4 shows a graph depicting a relationship between pumping current and pumping voltage for O₂ and NOx of varying concentrations for an exemplary NOx sensor. The initiation of the electrochemical dissociation of each of O₂ and NOx is shown by a rapid increase in pumping current. From this Figure, it can be seen that O₂ is dissociated at a lower pumping potential than NOx. Therefore, O₂ pumping potentials V0 and V1 may range from the voltage at which O₂ pumping current reaches steady state to that which is sufficient to cause NOx dissociation. Likewise, suitable NOx pumping potentials across electrodes 226 and 228 may include voltages sufficient to pump NOx, but not sufficient to pump other potentially interfering species with higher dissociation potentials, such as water.

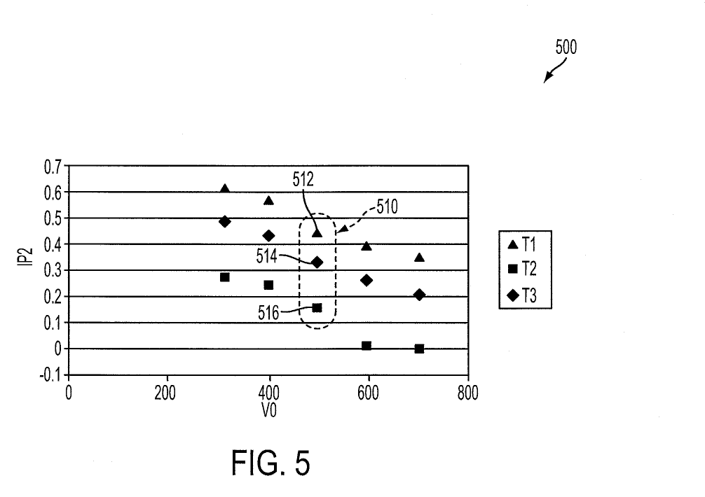

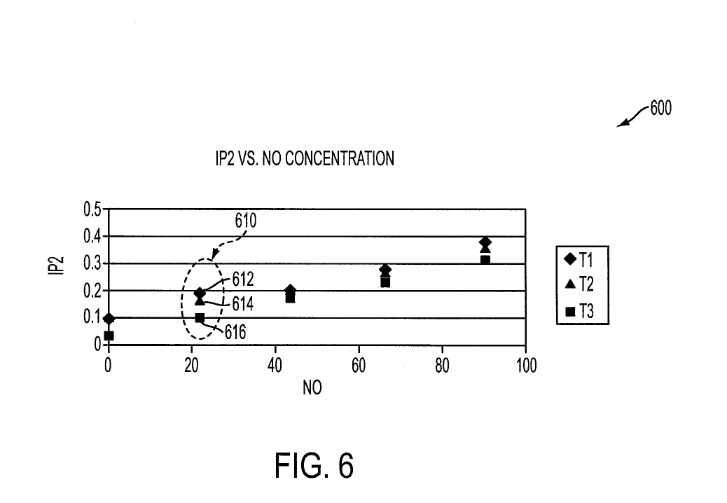

A sensor with good sensitivity and accuracy is desirable to detect low concentrations of NOx for emission compliance and to optimize emission control. However, as described above, factors such as unit-to-unit variation and sensor aging may contribute to the inaccurate measurement of NOx in some sensors. In particular, these factors may result in the development of conditions within the sensor that may cause polarizations changes within the electrolyte and at electrode-electrolyte interfaces. Such polarization changes may cause changes in the electrochemical properties of the sensor over time. For example, the NOx pumping current of an aged sensors may show a decay for controlled gas compositions over time. The NOx concentration output signal may be affected by such changes to the extent that the accuracy of an aged sensor may be lower than that of a newer sensor. In addition, the measured current may be relatively small at very low NOx concentrations. In these situations, relatively low signal-to-noise ratios may result in less accuracy. The exemplary graphs in FIGS. 5-6 illustrate such decay in NOx pumping currents and the resulting impact on the NOx concentration output signal.

First referring to FIG. 5, graph 500 illustrates an example of a decay of NOx pumping currents as a function of measurement time changes. FIG. 5 also illustrates the effect of increasing V0 on the concentration of oxygen in the second internal cavity. The data shown in graph 500 was obtained via the following experimental conditions (with reference to the NOx sensor illustrated in FIG. 2): V1 (the second oxygen pumping electrode) was set to be 385 mV while V0 (the first oxygen pumping electrode) was varied. For each V0, a V2 (the NOx measuring electrode) pulse of 400 mV was applied, and the resulting Ip2 (NOx pumping current) was measured. The test gas mixture was 1% O₂, 4% CO₂, 100 ppm NO, and the balance gas was N₂. Measurements were made at T1=2.2 seconds, T2=3.4 seconds, and at T3=300 seconds (which corresponds to a steady-state value), after applied a 400 mV voltage pulse.

From the results shown in graph 500, it can be seen that, for each measured V0, the measured NOx pumping current drops over time after the initial application of the pumping voltage. Further, the decrease in signal magnitude with increasing V0 may result from more oxygen being removed by the oxygen pumping electrodes at higher V0 than at lower V0, and therefore less residual oxygen reaching the measuring electrodes. To specifically illustrate pumping current decay, three exemplary NOx pumping current measurements taken at a single value of V0 are shown generally at 510. In data set 510, data point 512 represents the NOx pumping current at 2.2 seconds, data point 514 represents the NOx pumping current at 3.4 seconds, and data point 516 represents the NOx pumping current after 300 seconds at steady state. It can be seen from these data that a significant drop in NOx pumping current, from about 0.45 mA to about 0.15 mA, occurs between initially applying the pumping voltage and reaching steady state output levels.

This decay is further illustrated in FIG. 6, which shows the decay of the NOx pumping current as a function of time for various NO concentrations. The data shown in graph 600 was obtained via the following experimental conditions (with reference to the NOx sensor illustrated in FIG. 2): V1 (the second oxygen pumping electrode) was set to be 385 mV, and IP1 was set to be 7 microamps. The gas mixture composition, in addition to varying amounts of NO, also included 1% O₂, 4% CO₂, and balance N₂. Measurements were made at T1=3 seconds, T2=5 seconds, and at T3=300 seconds which corresponds to steady-state.

From the results shown in graph 600, it can be seen that, for each measured NO concentration, the measured NOx pumping current drops over time after the initial application of the pumping voltage. Data set 610 illustrates three exemplary NOx pumping current measurements taken at a single gas mixture composition are shown at 610. In this data set, data point 612 represents the NOx pumping current at 3 seconds, data point 614 represents the NOx pumping current at 5 seconds, and data point 616 represents the NOx pumping current at steady state. It can be seen from these data that a significant drop in NOx pumping current, from about 0.2 mA to about 0.1 mA, occurs between initially applying the pumping voltage and reaching steady state output levels.

Without wishing to be bound by theory, the decay shown in FIGS. 5 and 6 may be affected by impedance related to polarization effects in the electrolyte and electrode-electrolyte interfaces that are initially lower when the measuring electrode voltage pulse V2 is applied, and that increase as a function of time. An aged sensor with aged electrolyte and electrodes may have relatively greater polarizations and thus greater impedances. These age related effects may reduce the measured current and thus may result in relatively lower NOx concentration value output. The transient signal is relatively less affected by the aging effect. Therefore, prolonging the detection of the current or using a steady state measurement of current may result in measured values of IP2 that may be lower, and less accurate than, the immediate current response as a result of illustrated decay. Further, the immediate current response may include fewer contributions from the polarization effects in the sensor. In addition, measurements performed at different times may provide NOx concentration level information that may be used in self-verification or to determine an average of the measured data to use in determining a NOx concentration.

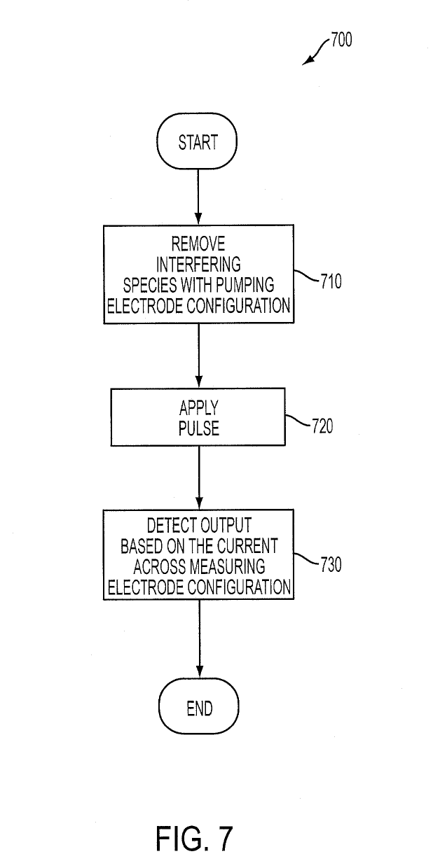

To reduce the impact of aging-related impedances on the sensor performance, the NOx pumping current IP2 may be measured immediately after or shortly after applying a voltage pulse to the NOx measuring electrodes, rather than at steady state. FIG. 7 shows, generally at 700, a flowchart of an exemplary embodiment of a method of measuring the concentration of NOx via a NOx sensor. While described in the context of a NOx sensor, it will be understood that method 700 may be used with any other suitable type of gas sensor. It will be appreciated that method 700 may be controlled in any suitable manner, including but not limited to by executable instructions stored on and executed by controller 12.

Method 700 includes, at step 710, removing any species from the sensor that may interfere with the measurement of the analyte, applying a voltage at step 720 to dissociate NOx in the measuring electrode configuration, and then, at step 730, detecting an output signal based on a current through the measuring electrode configuration before the current through the measuring electrode decays to a steady-state value.

Referring first to step 710, where the sensor is a NOx sensor, the interfering species removed by the pumping electrode concentration may be O₂. The process of electrochemically pumping the oxygen out of first internal cavity 212 may include applying an electric potential V0 across first pair of pumping electrodes 214, 216 that is sufficient to dissociate molecular oxygen, but not sufficient to dissociate NOx.

In some embodiments, the NOx sensor may include more than one pumping electrode for removing interfering species. In these embodiments, the additional pumping electrodes may likewise be set at an appropriate potential V1 to remove any residual oxygen that was not removed by first pair of pumping electrodes, but not to dissociate and pump any NOx gases. In some embodiments, the potentials of each pair of pumping electrodes may be operated at the same or similar levels. In other embodiments, the potentials may increase in magnitude in different sections of the sensor as oxygen is depleted from the analytical sample. As such, the potential applied to additional pumping electrode configurations disposed between the first pumping electrode configuration and the measuring electrode configuration may increase in magnitude accordingly. Accordingly, the analytical sample may be introduced to the measuring electrode configuration substantially free of oxygen that may interfere with the accurate measurement of NOx concentration.

Referring next to step 720, any suitable pulse may be applied to the measuring electrodes to dissociate the analyte. In the context of a NOx sensor, suitable NOx pumping potentials across electrodes 226 and 228 may include voltages sufficient to pump NOx without dissociating and pumping potentially interfering species that are present in the analytic sample. Such potentials may include potentials between approximately 0.7 V, where NOx dissociation begins, and potentials that may cause the dissociation and electrochemical pumping of the potential interfering species, such as water, which may begin dissociation at approximately 1.2 V.

The pulse applied to the measuring electrodes may also have any suitable width, frequency and profile. For example, the pulse may have a width equal to or greater than the duration of the current measurement to be taken from the measuring electrodes. The use of a shorter duration pulse may allow more frequent measurements to be acquired. However, some amount of time may be required for the time-dependent impedance effects to relax to their initial values upon removal of a potential across the measuring electrodes. Therefore, the pulse width and frequency may be selected based upon measurement times and frequencies determined to be sufficient to allow accurate NOx concentration measurements. In yet other embodiments, a plurality of pulses may be applied for the acquisition of one measurement, rather than a single pulse.

Next referring to step 730, the output signal may be detected and processed in any suitable manner. For example, in some embodiments, the output may correspond to a single current measurement. In these embodiments, the single current measurement may have any suitable duration and be taken over any suitable time interval. As previously discussed, delaying the detection of the current or using a steady state measurement of current may result in relatively low values of the measured current. As such, the single current measurement may be taken immediately after or shortly after applying a pulse to the measuring electrodes, rather than at steady state.

Under some conditions, various electronic disturbances, such as voltage spikes, may affect a NOx measurement. Therefore, in alternate embodiments, the output signal may be based on a statistical value that may include the average, median, or other statistically determined value, of a plurality of current measurements.

Likewise, the duration of each current measurement may have any suitable value. In one embodiment, the NOx pumping current may be measured for a predetermined duration of time, number of engine cycles, etc., after the pulse is applied. Examples of suitable durations include, but are not limited to, durations of less than or approximately 0.1 milliseconds-10 seconds. Alternatively, the duration of the current measurement may be defined by the time interval between the start of the signal applied and the point at which the measured current decays to a predetermined percentage or value below the initial measured current. Because the impedance contributions from polarization effects may increase with time, the current may be measured for a sufficiently short duration so that such impedance contributions do not contribute substantially to the measured current. It will be appreciated that the values given above are merely exemplary, and that any other suitable decay time or measurement may be used to determine the duration of the current measurement.

It may be appreciated that the order of processing to be detailed is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into a computer readable storage medium for the sensor, for example, in the engine control system.

Furthermore, it will be appreciated that the various embodiments of gas sensors and methods of operating gas sensors disclosed herein are exemplary in nature, and these specific embodiments are not to be considered in a limiting sense, because numerous variations are possible. The subject matter of the present disclosure includes all novel and non-obvious combinations and subcombinations of the various sensors, methods of operating sensors, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the various features, functions, elements, and/or properties disclosed herein may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. In a vehicle comprising an internal combustion engine, a method of operating an electrochemical gas sensor, comprising:
applying a voltage pulse across a measuring electrode pair; and
detecting a current through the measuring electrode pair during the voltage pulse before the current decays to a steady state level.

2. The method of claim 1, wherein the voltage pulse has a width less than approximately 0.1 millisecond-10_seconds.

3. The method of claim 1, wherein detecting the current before the current decays to a steady state level comprises detecting the current between approximately zero and five seconds after applying the voltage pulse.

4. The method of claim 1, further comprising applying a continuous voltage to a pumping electrode pair to at least partially remove an interfering species from the sensor.

5. The method of claim 1, wherein the sensor is a NOx sensor.

6. The method of claim 1, further comprising adjusting an engine operating condition in response to detecting the current through the measuring electrode pair.

7. The method of claim 1, wherein the voltage pulse has a magnitude of between approximately 0.1 and 1.2 volts.

8. The method of claim 1, further comprising applying another voltage pulse before again detecting the current through the measuring electrode pair.

9. In a vehicle comprising an internal combustion engine, a method of operating an electrochemical gas sensor, comprising:
applying a continuous voltage across a first electrode pair, wherein the continuous voltage is sufficient to electrochemically pump an interfering species from the sensor but insufficient to pump an analyte from the sensor;
applying a pulsed voltage across a measuring electrode pair; and
measuring a current through the measuring electrode pair during at least one voltage pulse.

10. The method of claim 9, wherein the voltage pulse has a width of less than approximately _{—}0.1 millisecond-10_seconds.

11. The method of claim 9, wherein measuring the current through the measuring electrode comprises measuring the current before the current decays to a steady state level.

12. The method of claim 11, wherein the current is measured between approximately zero and five seconds after applying the voltage pulse.

13. The method of claim 9, wherein the sensor is a NOx sensor.

14. The method of claim 9, further comprising adjusting an engine operating condition in response to detecting the current through the measuring electrode pair.

15. The method of claim 9, wherein the voltage pulse has a magnitude of between approximately 0.1 and 1.2 volts.

16. The method of claim 9, further comprising applying another voltage pulse across the measuring electrode pair before again measuring the current through the measuring electrode pair.

17. An apparatus, comprising:
an internal combustion engine;
an emissions system;
an electrochemical gas sensor positioned to detect a concentration of a gaseous species in the emissions system; and
a controller configured to control operation the electrochemical gas sensor, wherein the controller comprises instructions stored in memory and executable by the controller to:
apply a continuous voltage across a first electrode pair, wherein the continuous voltage is sufficient to electrochemically pump an interfering species from the sensor but insufficient to pump an analyte from the sensor;
apply a pulsed across a measuring electrode pair; and
measure a current through the measuring electrode pair during at least one voltage pulse.

18. The apparatus of claim 17, wherein the voltage pulse has a width of less than approximately _{—}0.1 millisecond-10_seconds.

19. The apparatus of claim 17, wherein the controller is configured to measure the current through the measuring electrode comprises by measuring the current before the current decays to a steady state level.

20. The apparatus of claim 19, wherein the current is measured between approximately zero and five seconds after applying the voltage pulse.

21. The apparatus of claim 17, wherein the sensor is a NOx sensor.

22. The apparatus of claim 17, wherein the controller further comprises instructions executable by the controller to adjust an engine operating condition in response to detecting the current through the measuring electrode pair.

23. The apparatus of claim 17, wherein the voltage pulse has a magnitude of between approximately 0.1 and 1.0 volts.

24. The apparatus of claim 17, wherein the controller further comprises instructions executable by the controller to apply another voltage pulse across the measuring electrode pair before again measuring the current through the measuring electrode pair.
